(19) United States
(12) Patent Application Publication
(10) Pub. No.: US 2026/0059368 A1
(43) Pub. Date: Feb. 26, 2026

(54) LAG-SELECTIVE TIME CORRELATION REPORTING

(71) Applicant: QUALCOMM Incorporated, San Diego, CA (US)

(72) Inventors: Jing DAI, Beijing (CN); Lei XIAO, San Jose, CA (US); Jae Ho RYU, San Diego, CA (US); Faris RASSAM, El Cajon, CA (US); Wei XI, Beijing (CN); Liangming WU, Beijing (CN); Yu ZHANG, San Diego, CA (US)

(21) Appl. No.: 19/103,751

(22) PCT Filed: Sep. 30, 2022
(86) PCT No.: PCT/CN2022/123289

§ 371 Date: Feb. 13, 2025

(51) Int. Cl. H04W 24/10; H04L 5/00; H04W 52/02

(52) U.S. Cl. CPC H04W 24/10; H04L 5/0094; H04W 52/0238

(57) ABSTRACT

Certain aspects of the present disclosure provide a method for wireless communications at a user equipment (UE), generally including receiving signaling configuring the UE to report time correlation for multiple lags of reference signals (RS), wherein each lag represents a separation in time between reference signals measured for time correlation and reporting time correlation for a subset of the multiple configured lags.

### BACKGROUND

### Field of the Disclosure

Aspects of the present disclosure relate to wireless communications, and more particularly, to techniques for lag-selective time correlation reporting.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications at a user equipment (UE). The method includes receiving signaling configuring the UE to report time correlation for multiple lags of reference signals (RS), wherein each lag represents a separation in time between reference signals measured for time correlation; and reporting time correlation for a subset of the multiple configured lags.

Another aspect provides a method for wireless communications at a network entity. The method includes transmitting signaling configuring a UE to report time correlation for multiple lags of RS, wherein each lag represents a separation in time between reference signals measured for time correlation; and receiving a reporting, generated by the UE, of time correlation for a subset of the multiple configured lags.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5A and FIG. 5B depict example connected-mode discontinuous reception (CDRX) timelines.

FIG. 6 depicts an example tracking reference signal (TRS) configuration.

FIG. 7 is a call-flow diagram for an example of lag-selective time correlation reporting, in accordance with certain aspects of the present disclosure.

FIG. 8A and FIG. 8B depict examples for time correlation reporting, in accordance with certain aspects of the present disclosure.

FIG. 9 depicts example quantization for different time correlation lags, in accordance with certain aspects of the present disclosure.

FIGS. 10A-10C depict options for supporting longer lags, in accordance with certain aspects of the present disclosure.

FIG. 11 depicts example use of a timeline anchor slot for lag-selective time correlation reporting, in accordance with certain aspects of the present disclosure.

FIG. 12 depicts a method for wireless communications.

FIG. 13 depicts a method for wireless communications.

FIG. 14 depicts aspects of an example communications device.

### DETAILED DESCRIPTION

Aspects of the present disclosure provide apparatuses, methods, processing systems, and computer-readable mediums for lag-selective time correlation reporting.

In some scenarios, it may be beneficial to perform channel state reporting that indicates time correlation (the correlation of channel measurements at different points in time). Time correlation reporting may be beneficial, for example, for user equipments (UEs) traveling at certain velocities, by exploiting time-domain correlation/Doppler-domain information to assist in downlink precoding.

In some cases, a UE may be configured to report time-domain channel properties (TDCP) based on channel state information reference signals (CSI-RS) used for tracking, referred to as tracking reference signals (TRS). TRS-based TDCP reporting may be based on time-domain correlation profile, for example, determined as a correlation within one TRS resource or a correlation across multiple TRS resources.

In some cases, a UE may be configured to report time correlation over one or more lags of TRS resource, where a lag refers to the time distance between measured TRS. The lags may be within one TRS burst or different TRS bursts. When configured for multiple lags (multi-lag) time-correlation reporting, the UE may need to measure TRS across multiple bursts. For example, a UE configured to report time correlation for M cross-burst lags, the UE may be required to measure at least M+1 TRS bursts.

Unfortunately, for some cases, the UE may not be able to obtain time correlation for all lags. For example, when discontinuous reception (DRX) is configured, TRS transmitted outside a DRX active time may not be received as the UE may be in a low power state. Further, in some systems (e.g., NR Release 15-17), it may be left up to the UE whether or not to receive a certain TRS burst/slot. Thus, there is some uncertainty in how a UE should behave when configured for multi-lag time-correlation reporting, but is unable to obtain time correlation for all lags.

Aspects of the present disclosure provide techniques that allow a UE to perform lag-selective time correlation reporting. The techniques provide various mechanisms that allow the UE to perform time-correlation reporting for only a subset of lags for which the UE is configured.

Potential advantages for the techniques include providing clarity on how a UE may behave when time-correlation for certain lags is unobtainable. Further, by allowing a UE to report time-correlation for the lags that are obtainable, the UE may be able to provide valuable feedback rather than not reporting at all. This feedback may result in more optimal downlink precoding, better system performance, and improved overall user experience.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

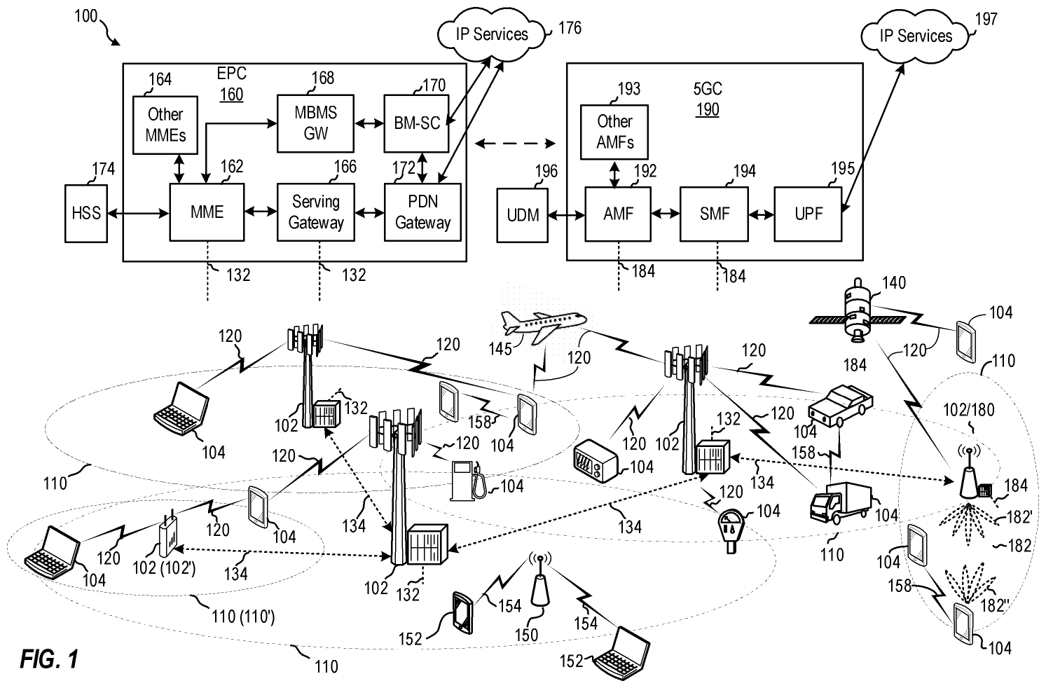

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

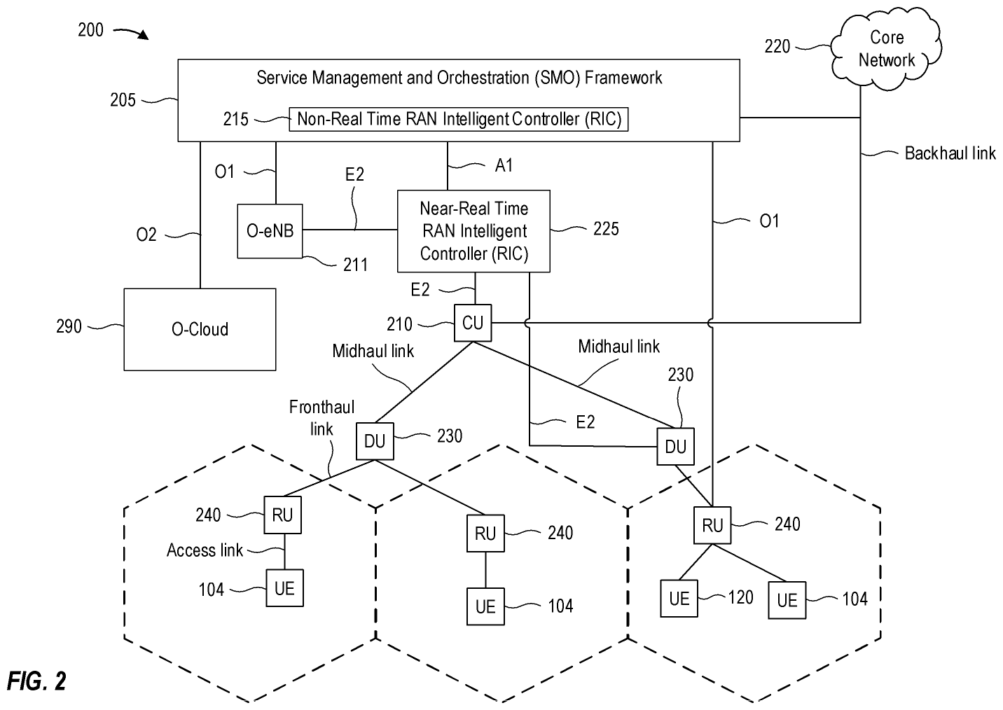

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUS), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mmWave”). A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

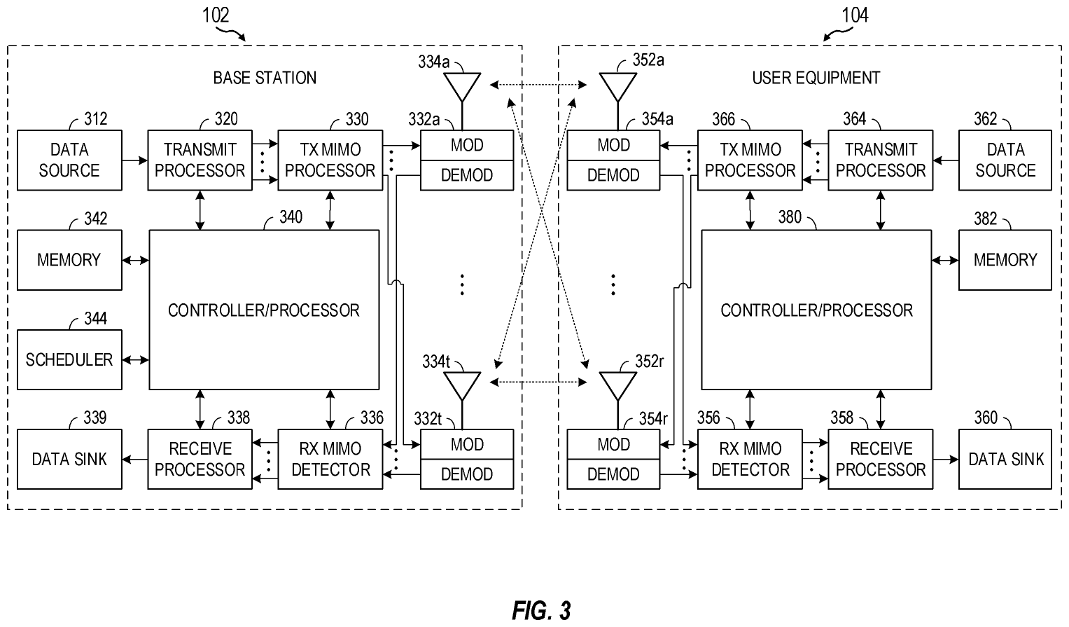

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

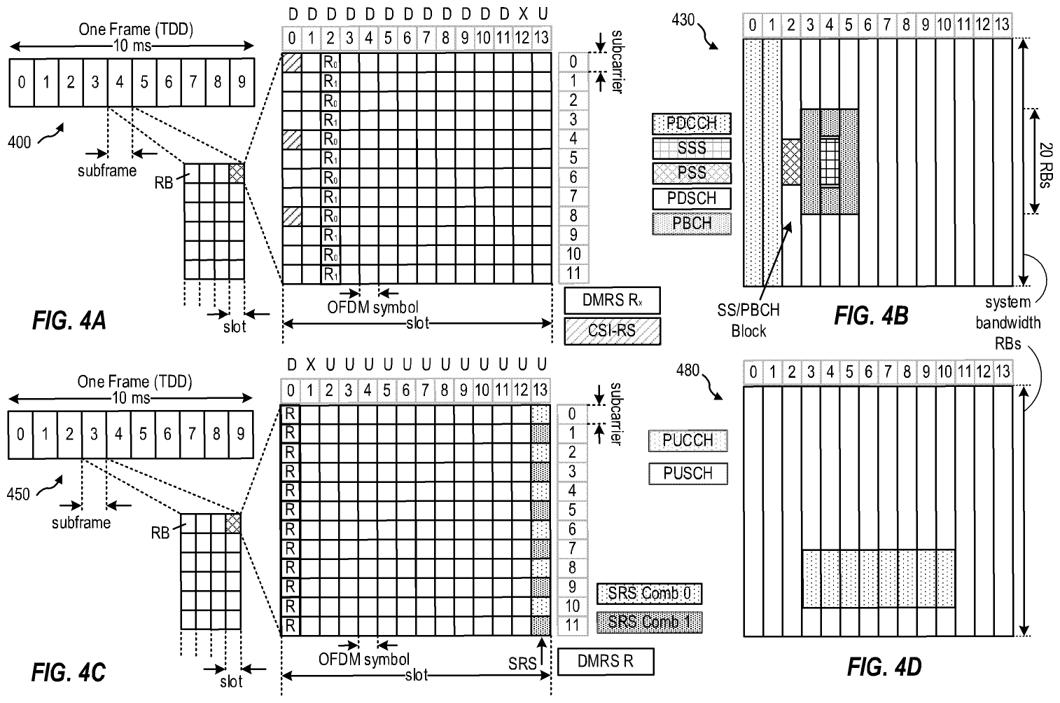

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 2μ slots/subframe. The subcarrier spacing and symbol length/duration are a function of the numerology. The subcarrier spacing may be equal to 24× 15 kHz, where u is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BAR), a power headroom report (PHR), and/or UCI.

### Overview of Discontinuous Reception

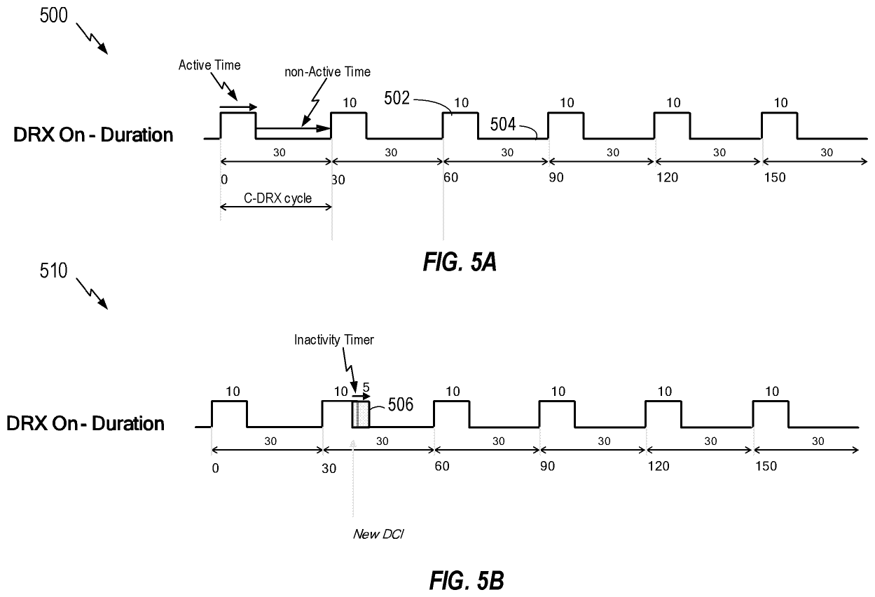

To reduce power consumption, a user equipment (UE) may be configured for discontinuous reception (DRX) operations. As illustrated the timing diagram 500 of FIG. 5A, during a connected DRX mode (CDRX), UE duration can be broadly divided into “Active time” durations 502 and “non-Active” time durations 504.

During a CDRX Active time (or On-Duration), the UE monitors for physical downlink shared channel (PDSCH) activity with a given periodicity or continuous monitoring, receives downlink data, transmits UL data, and/or makes serving cell or neighbor measurements. During Active time, a UE is generally considered “on” while various timers are running. For example, an Active duration timer (e.g., drx-onDurationTimer), an inactivity timer (drx-Inactivity Timer), and a complete DRX cycle duration (e.g., drx-ShortCycle) may run during an Active time. The beginning of a DRX cycle may be defined by a starting offset value.

In the examples shown in FIGS. 5A and 5B, the active time is 10 ms and the CDRX cycle duration is 30 ms. As illustrated the timing diagram 510 of FIG. 5B, the UE may be configured with an inactivity timer (starting an inactivity period 506) that restarts when activity is detected and expires after 5 ms without detected activity. When the inactivity timer expires, the UE enters an “inactive” or “sleep” mode.

In some cases, a UE may be configured with an enhanced CDRX (eCDRX) mode to mitigate drift in latency resulting from misalignment with traffic burst arrivals. Current CDRX mode is configured for integer value periodicity, while typical multimedia data traffic update rates (e.g., 60 Hz, 90 Hz, 45 Hz, 120 Hz, or 48 hz) often lead to non-integer value periodicity.

### Overview of TRS Configuration

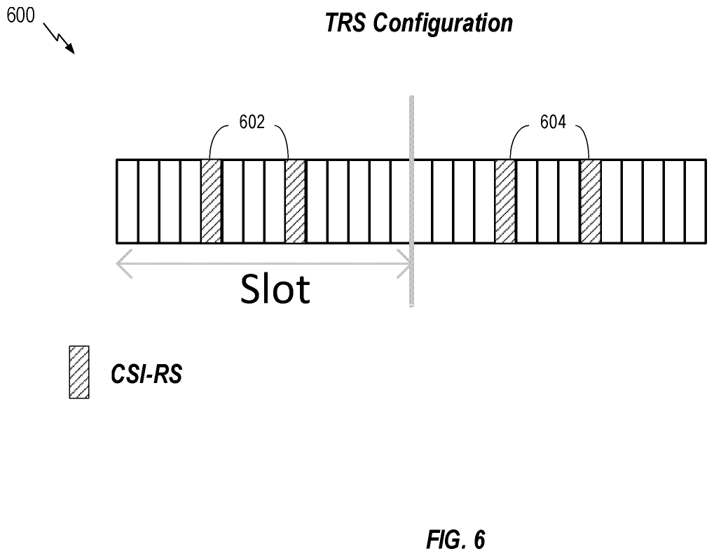

As illustrated in diagram 600 FIG. 6, a TRS (burst) may be configured as a CSI-RS resource set (configured with parameter trs-Info). The CSI-RS resource set may have 2 CSI-RS resources 602 in one slot, or 4 CSI-RS resources 604 in 2 consecutive slots (each slot with 2 CSI-RS resources).

Each of the CSI-RS resources may be single-port, and transmitted in the same bandwidth (BW) and on the same subcarriers/REs. Each CSI-RS resource may have a frequency domain (FD) density of 3 REs per RB.

Periodic TRS (P-TRS) and aperiodic TRS (AP-TRS) may be configured. For P-TRS, all of the 2 or 4 CSI-RS resources within the set may have the same periodicity, bandwidth, and frequency location. An AP-TRS configuration should have a corresponding P-TRS with the same bandwidth and frequency location, and quasi co-located (QCLed) with ‘QCL-typeA’ or ‘QCL-typeD.’

In certain systems, TRS may be used only for DL tracking (up to UE implementation) and may not be relevant to CSI reporting. Thus, a UE may not expect to be configured with a CSI-ReportConfig with the higher layer parameter reportQuantity set to other than ‘none’ for aperiodic NZP CSI-RS resource set configured with trs-Info. Further, a UE may not expect to be configured with a CSI-ReportConfig for periodic NZP CSI-RS resource set configured with trs-Info.

### Overview of Time-Domain Correlation Profile

As noted above, a UE may be configured to report time correlation over one or more lags of TRS resource, where a lag refers to the time distance between measured TRS. The lags may be within one TRS burst or different TRS bursts. When configured for multiple lags (multi-lag) time-correlation reporting, the UE may need to measure TRS across multiple bursts.

Time-correlation values A(τ) may be normalized so the reported values are within a range of 0 to 1: A(τ)∈(0,1). There are various alternatives for normalizing time correlations values taken for TRS separated by lag values τ. According to a first alternative (Alt 1):

$$A ( τ ) = \frac{\vert {\sum }_{k} Y * ( l - τ , k ) Y ( l , k ) \vert}{\frac{1}{2} ( {\sum }_{k} {\vert Y ( l - τ , k ) \vert}^{2} + {\sum }_{k} {\vert Y ( l , k ) \vert}^{2} )} ;$$

According to a second alternative (Alt 2):

$$A ( τ ) = \vert \frac{1}{K} {\sum }_{k} \frac{Y * ( l - τ , k ) Y ( l , k ) \vert}{\vert Y ( l - τ , k ) \vert \cdot \vert Y ( l , k ) \vert} \vert ;$$

where Y(l, k) denotes received/measured value on symbol l and subcarrier k, τ denotes lag of the time-correlation, and K denotes total REs for a TRS symbol.

Optionally, additional time filtering (e.g. averaging) over more symbols l can be applied (L denotes total symbols): According to a first alternative (Alt 1):

$$A ( τ ) = \frac{\vert {\sum }_{l} {\sum }_{k} Y * ( l - τ , k ) Y ( l , k ) \vert}{\frac{1}{2} ( {\sum }_{l} {\sum }_{k} {\vert Y ( l - τ , k ) \vert}^{2} + {\sum }_{l} {\sum }_{k} {\vert Y ( l , k ) \vert}^{2} )} ;$$

or according to a second alternative (Alt 2):

$$A ( τ ) = \vert \frac{1}{LK} {\sum }_{l} {\sum }_{k} \frac{Y * ( l - τ , k ) Y ( l , k )}{\vert Y ( l - τ , k ) \vert \cdot \vert Y ( l , k ) \vert} \vert .$$

In a multi-lag time-correlation report (profile) a larger lag τ generally corresponds to a lower speed UE, while a smaller lag τ generally corresponds to a higher speed UE. For example, for f_{c}=2 GHz, with a certain channel like TDL-A, lag τ=5 msec may work well with UE speed lower than 20 km/h, while lag τ=1 msec lag may work well with UE speed higher than 50 km/h. An algorithm can be implemented to choose an accurate one if multiple A(τ) s associated with different lags are reported.

To realize time-correlation with different lags, both intra-burst and inter-burst may be needed. For example, a 1 msec lag can be achieved by intra-burst TRS symbols (15 kHz SCS), a 10 msec lag can be achieved by inter-burst with P-TRS (minimum periodicity is 10 msec), while a 5 msec lag may be achieved with two P-bursts (or a P-burst and an AP-burst).

### Aspects Related to Lag-Selective Time Correlation Reporting

As noted above, for some cases, a UE may not be able to obtain time correlation for all lags. For example, when discontinuous reception (DRX) is configured, TRS transmitted outside a DRX active time may not be received as the UE may be in a low power state. Thus, there is some uncertainty in how a UE should behave when configured for multi-lag time-correlation reporting, but is unable to obtain time correlation for all lags.

Aspects of the present disclosure provide techniques that allow a UE to perform lag-selective time correlation reporting. The techniques provide various mechanisms that allow the UE to perform time-correlation reporting for only a subset of lags for which the UE is configured.

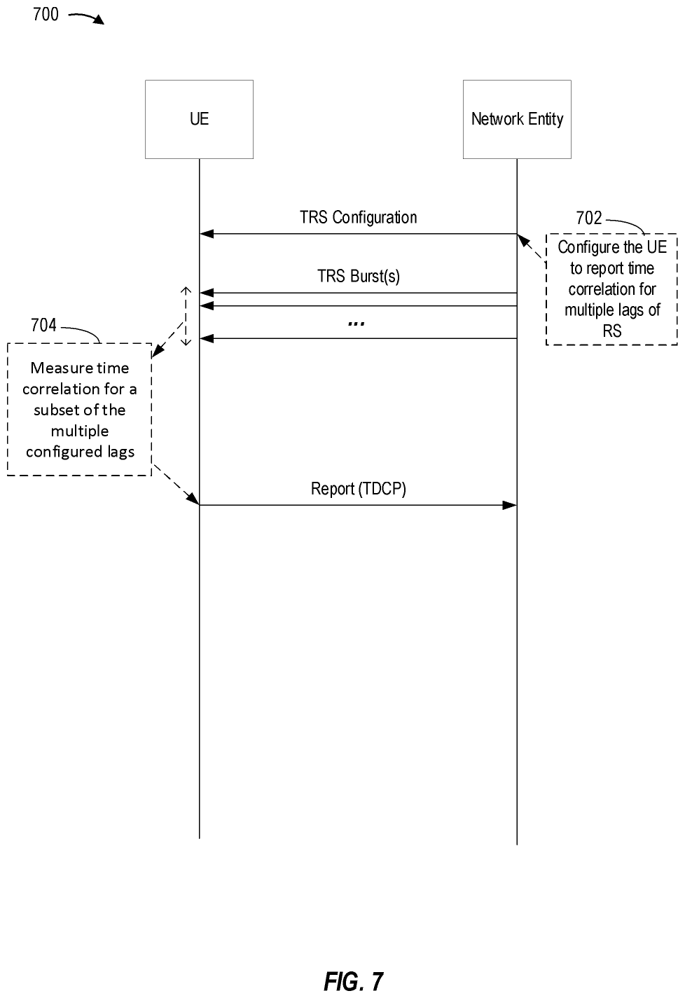

Lag-selective time correlation reporting proposed herein may be understood with reference to the call flow diagram 700 of FIG. 7 which shows example signaling between a UE and network entity. The UE may be an example of one of the UEs 104 illustrated in FIG. 1 or FIG. 3. The network entity may be an example of a base station 102 illustrated in FIG. 1 or FIG. 3 or a node of a disaggregated base station, as illustrated in FIG. 2.

As illustrated, at 702, the network may configure the UE to report time correlation for multiple lags of reference signals (RS). As noted above, each lag represents a separation in time between reference signals measured for time correlation.

At 704, the UE measures time correlation for a subset of the multiple configured lags, based on one or more TRS bursts. The UE reports the time correlation for the subset, for example, in a time domain correlation properties (TDCP) report.

In this manner, a UE configured for multiple configured lags (Ts) for the report of time-correlation A(τ) based on TRS measurement, is allowed to only report A(τ) value(s) for a subset with one or more lags. For example, assuming the UE is configured with a list of lags e.g. {1 msec, 5 msec, 10 msec, 20 msec} can be configured, the UE may not be able obtain time correlation for lags 10 msec and 20 msec. Thus, the UE may only report only valid A(τ) value(s) for {1 msec, 5 msec} due to measurement availability.

As noted above, in some systems, TRS is used for DL tracking, and whether receive it or not is up to UE implementation. For example, in such cases, the UE may be allowed to sleep (e.g., with no receiving or enter micro-sleep within a slot) or wake-up to receive TRS as it sees fits. The UE may be free to rely on SSBs for DL tracking, for example, if TRSs SNR is poor. For example, TRS SNR may be poor due to collision with a neighbor cell DL transmission.

In some cases, when a UE is configured with DRX, the UE may not be able to receive TRS outside the DRX active time. Existing standards do not define UE behavior for TRS receiving under DRX. It may be assumed that for existing typical UE implementations, TRS (at least for the typical configured P-TRS) is not received outside DRX active time.

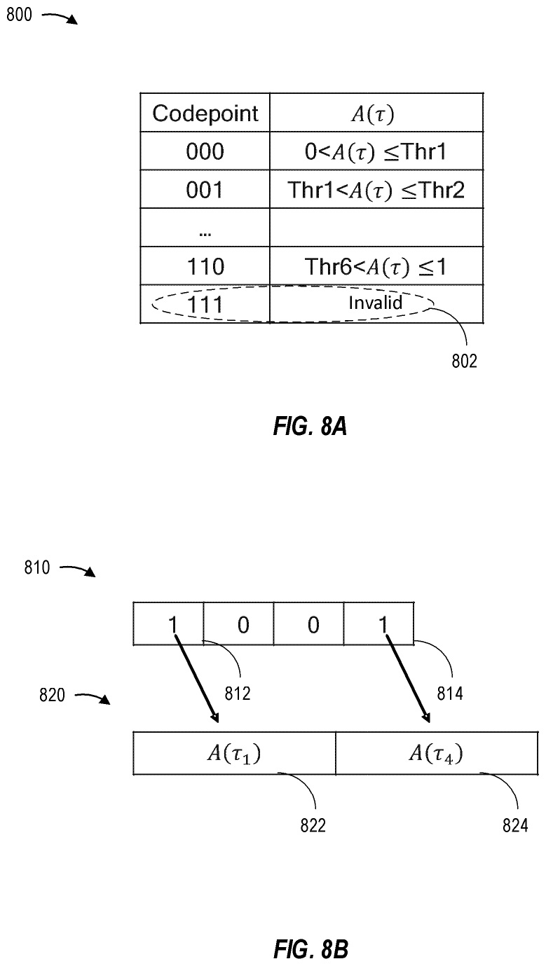

There are various options for lag-selective reporting. According to a first option, lag-selective reporting may be performed in a single stage report. In this case, as illustrated in table 800 of FIG. 8A, for A(τ) value quantization, there may be a codepoint 802 representing “invalid.” A UE may, thus, use this codepoint for lags where time correlation is unobtainable.

According to a second option, lag-selective reporting may be performed in multiple states. For example, as illustrated in FIG. 8B, in a first stage, a first reporting field 810 may indicate which lag(s) are reported (e.g., by a bitmap), while in a second state, a second reporting field 820 may indicate the A(τ) value(s) of the selected lag(s). In the example illustrated in FIG. 8B, bits 812 and 814 indicates the second reporting field contains A(τ) values of lags τ1 and τ4.

In existing standards, CSI may be divided into two parts (CSI part1 and CSI part2). In general, CSI part 1 information is considered more significant and has a smaller payload size (and is transmitted with higher reliability). A basic rule, CSI part 1 has a fixed payload size, while the payload size of CSI part 2 may be determined based on the decoded part 1. In some cases, the first stage information may be reported in CSI part 1, while the second stage information may be reported in CSI part 2. The two-stage option may have smaller reporting overhead than the single stage option, due to the variable quantities of reported A(τ) value(s).

In some cases, there may be a restriction on UE capability for time correlation reporting. In some cases, for time correlation (profile) report, at least one of the following may be configured for a UE: a maximum lag τₘₐₓ, a maximum number of lags configured for A(τ) reporting, or a maximum number of lags with A(τ) value reported in a single report. One or more of these values may depend on UE capability reported by the UE. These values may be designed to limit the buffer requirement for the UE, as a longer lag or more lags requires a larger buffer for previously received TRS measurements Y(l−τ,k), τ=τ₁, . . . , τ_{M}, k=0, 1, . . . , 3N_{RB}−1).

As noted above, time correlation values may be normalized to be in the range of 0 to 1: A(τ)∈(0,1). According to certain aspects, for time-correlation with a single sample, the normalization may be determined by the product of two respective quantities of the two symbols (separated by the lag), such as the sum of square of received signal amplitude at each RE. For example, a definition of time-correlation for a single sample (between a pair of symbols separated by lag t) may be:

$$A ( τ ) = \frac{\vert {\sum }_{k} Y * ( l - τ , k ) Y ( l , k ) \vert}{\sqrt{{\sum }_{k} {\vert Y ( l - τ , k ) \vert}^{2}} \sqrt{{\sum }_{k} {\vert Y ( l , k ) \vert}^{2}}} .$$

For more than one sample(-pair) s the definition of time-correlation may be:

$$A ( τ ) = \frac{\vert {\sum }_{l} {\sum }_{k} Y * ( l - τ , k ) Y ( l , k ) \vert}{\sqrt{{\sum }_{l} {\sum }_{k} {\vert Y ( l - τ , k ) \vert}^{2}} \sqrt{{\sum }_{l} {\sum }_{k} {\vert Y ( l , k ) \vert}^{2}}} or A ( τ ) = {\sum }_{l} \frac{\vert {\sum }_{k} Y * ( l - τ , k ) Y ( l , k ) \vert}{\sqrt{{\sum }_{k} {\vert Y ( l - τ , k ) \vert}^{2}} \sqrt{{\sum }_{k} {\vert Y ( l , k ) \vert}^{2}}} .$$

These definitions may be relatively robust against random phase jump between symbol l−τ and symbol l. When compared with the first alternative (Alt1) for normalization described above, this definition may also be more robust against automatic gain control (AGC) between symbol l−τ and symbol l.

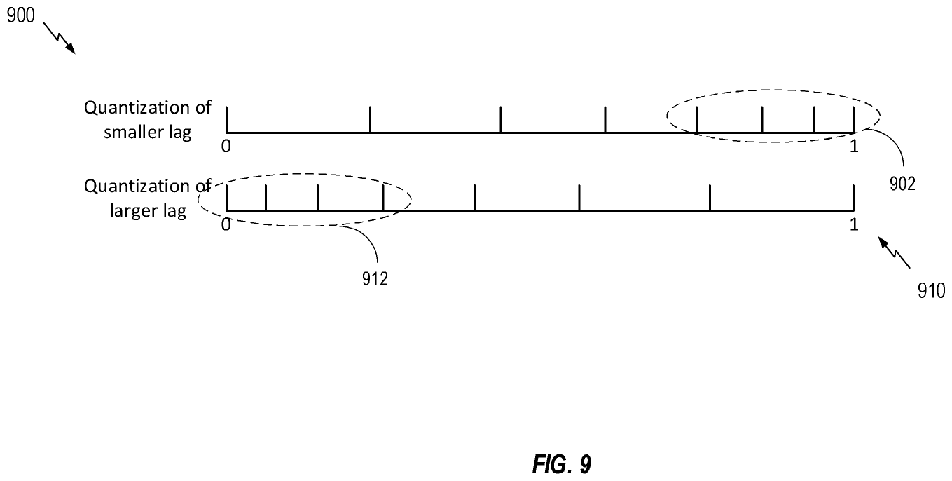

In some cases, time correlation values for different lags are reported with different quantization intervals, meaning there may be lag-specific quantization of A(τ). Diagrams 900 and 910 of FIG. 9 depicts example quantization for different time correlation lags, in accordance with certain aspects of the present disclosure. One reason for this is that, for smaller lag t, A(τ) can be larger, and more quantization intervals can be near 1, as shown at 902. On the other hand, for larger lag T, A(τ) can be smaller, and more quantization intervals should be near 0, as shown at 912.

Aspects of the present disclosure provide various options to support longer lags, which may help efficiently utilize resources. For example, for a lag that is longer than intra-burst period (e.g., 1 msec), but still relatively short with respect to TRS periodicity (e.g., 5 msec, 10 msec) P-TRS may be wasteful in terms of resource consumption.

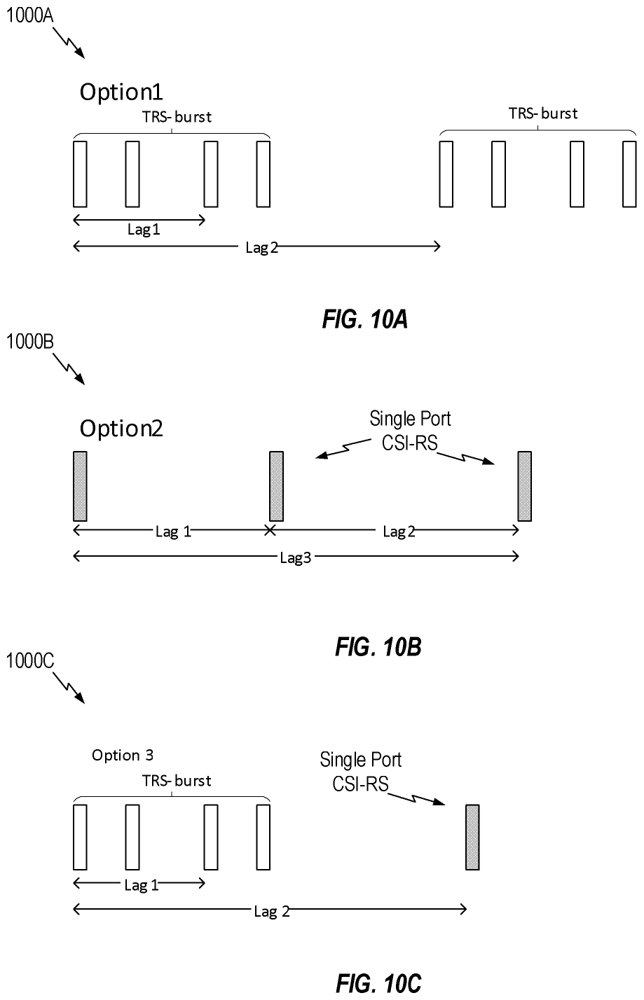

FIGS. 10A-10C depict options for supporting longer lags, in accordance with certain aspects of the present disclosure. As illustrated in the timing diagram 1000A of FIG. 10A, according to a first option, multi-burst AP-TRS (e.g., defined in Rel-17 for fast Scell activation) may be used. In this case, lag-selective reporting may not be needed (since all TRS bursts causally appear after the triggering PDCCH). As illustrated, this may allow for a first lag (Lag1) between TRS in the same burst (intra-burst) and a larger lag (Lag2) between TRS of different bursts.

As illustrated in the timing diagram 1000B of FIG. 10B, according to a second option, a new definition of CSI-RS resource set of single-port CSI-RSs, with different time spacing than existing TRS (either P/SP or AP) may be provided. As illustrated, the different time spacing may allow for a first lag (Lag1) between a first single-port CSI-RS and a second single-port CSI-RS, a second lag (Lag2) between the second single-port CSI-RS and a third single-port CSI-RS, and a third lag (Lag3) between the first single-port CSI-RS and a third single-port CSI-RS.

As illustrated in the timing diagram 1000B of FIG. 10B, according to a third option, a combination of a previously defined (so-called legacy) TRS burst along with one or more single-port CSI-RSs according to the first option (e.g., more than 4 symbols within this CSI-RS resource set configured). This approach may allow a first lag (Lag1) between TRS of the TRS burst and a second lag (Lag2) between a TRS of the burst and a single-port CSI-RS.

With the third option, the single-port CSI-RS may have a same QCL as the TRS burst. For the second and third options, with AP-CSI-RS (TRS), lag-selective reporting may not be needed. Although lag-selective reporting may still be needed for P-/SP-CSI-RS (TRS).

In some cases, there may be some timeline restrictions for CSI reference resources (e.g., to give a UE time to generate reporting values from measurements). For example, for a CSI-RS time resource, a valid DL slot may occur n-n_{CSI_ref} (prior to the UL slot n where the CSI is reported). For P/SP reporting, n_{CSI_ref} may be the smallest value that ≥4·2^{μ}^{_{DL}} (single CSI-RS) or ≥5· 2^{μ}^{_{DL}} (multiple CSI-RSs), such that slot n−n_{CSI_ref} corresponds to a valid DL slot. For an aperiodic report, n_{CSI_ref} may be the smallest value that ≥|└Z′/14┘, such that slot n−n_{CSI_ref} corresponds to a valid DL slot (where Z′ is the required processing timeline for CSI-RS to reporting PUSCH). A PDSCH pattern may be assumed, including used symbols within the slot, DMRS pattern, SCS, and a layer mapping pattern associated with the reported PMI.

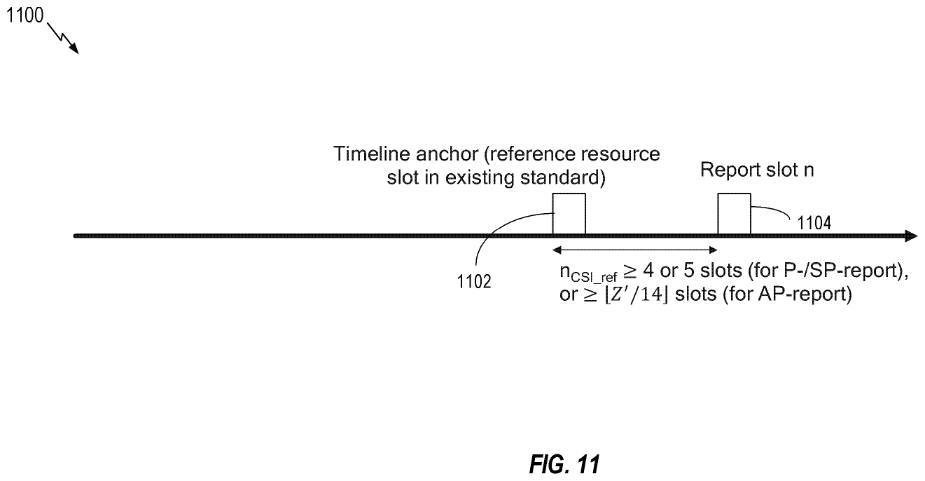

FIG. 11 depicts example use of a timeline anchor slot for lag-selective time correlation reporting, in accordance with certain aspects of the present disclosure.

In some cases, there may not be a need to define a reference resource for A(τ) report (e.g., a slot defined as the time for which this reported A(τ) value stands), but only to define what may be referred to as a timeline anchor slot.

FIG. 11 depicts example use of a timeline anchor slot 1102 for lag-selective time correlation reporting sent in a slot 1104, in accordance with certain aspects of the present disclosure. According to certain aspects, a UE may only need to report A(τ) via TRS measurement no later than timeline anchor slot. For this relatively loose timeline, there may be no need to restrict reporting to be based on a most recent TRS burst (for intra-burst lag) or two most recent TRS bursts (for cross-burst lag) for A(τ) report, as long as the reporting is based on TRS measurement is no later than the timeline anchor slot. In the illustrated example, the timeline anchor slot 1102 (analogous to the reference resource slot in existing standard) may occur n_{CSI_ref} before the reporting slot, for example, with n_{CSI_ref}≥4 or 5 slots for a P-/SP-reporting or n_{CSI_ref}≥└Z′/14┘ slots for an AP-reporting. In some cases, even with TRS configured with A(τ) report, the UE may not expect to be configured with timeRestrictionForChannelMeasurements (same as TRS in current standard without a report configured).

As noted above, DRX may impact time correlation reporting. There are various options for defining UE behavior for time correlation reporting in DRX.

For example, a first option may follow an existing CSI mechanism, where the UE only needs to report most recent A(τ) of one or more lags based on TRS(s) received within DRXactiveTime. In other words, the UE does not need to receive TRS outside DRX active time. When configured with a wake-up signal (used to signal the UE whether or not it needs to wake up for a DRX On duration, if the UE is configured with TransmitOtherPeriodicCSI, the UE may additionally only need to report a most recent A(τ) of one or more lags based on TRS(s) received in DRX ON duration outside of DR XactiveTime. For TRSs within DRX active time (or additionally DR XonDuration outside DRXactiveTime, when the above WUS plus parameter TransmitOtherPeriodicCSI configured), the UE may use lag-selective reporting as proposed herein.

According to a second option, a UE may perform lag-selective reporting regardless of whether TRS is within/outside DRXactiveTime. In some cases, following current CSI reporting rules under DRX, a UE may not need to report P-/SP-report of A(τ) outside DRXactiveTime either. In some cases, when configured with WUS and if configured with TransmitOtherPeriodicCSI, a P-/SP-report of A(τ) can additionally be reported by the UE in DRXonDuration outside DRXactiveTime.

By allowing a UE to perform lag-specific time-correlation reporting, the UE may be able to provide valuable feedback, even when some configured lags are not obtainable. This feedback may result in more optimal downlink precoding, better system performance, and improved overall user experience.

### Example Operations of a User Equipment

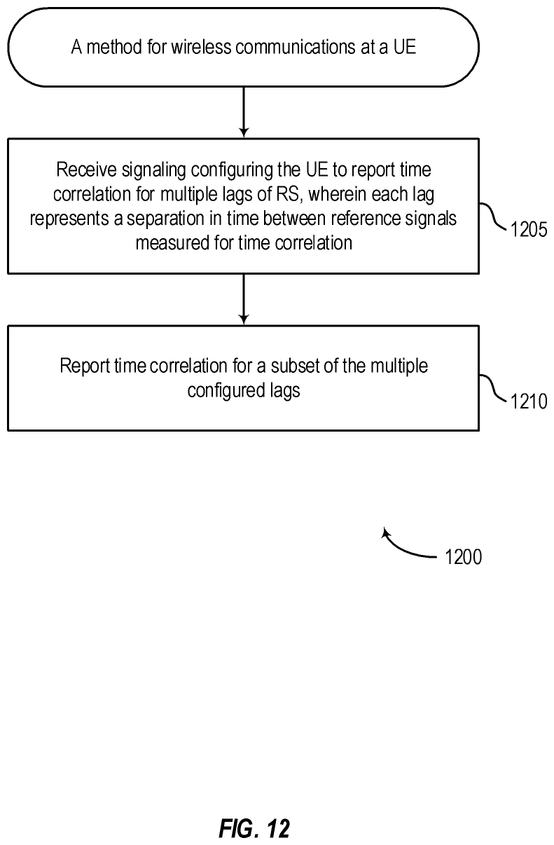

FIG. 12 shows an example of a method 1200 for wireless communications at a UE, such as UE 104 of FIGS. 1 and 3.

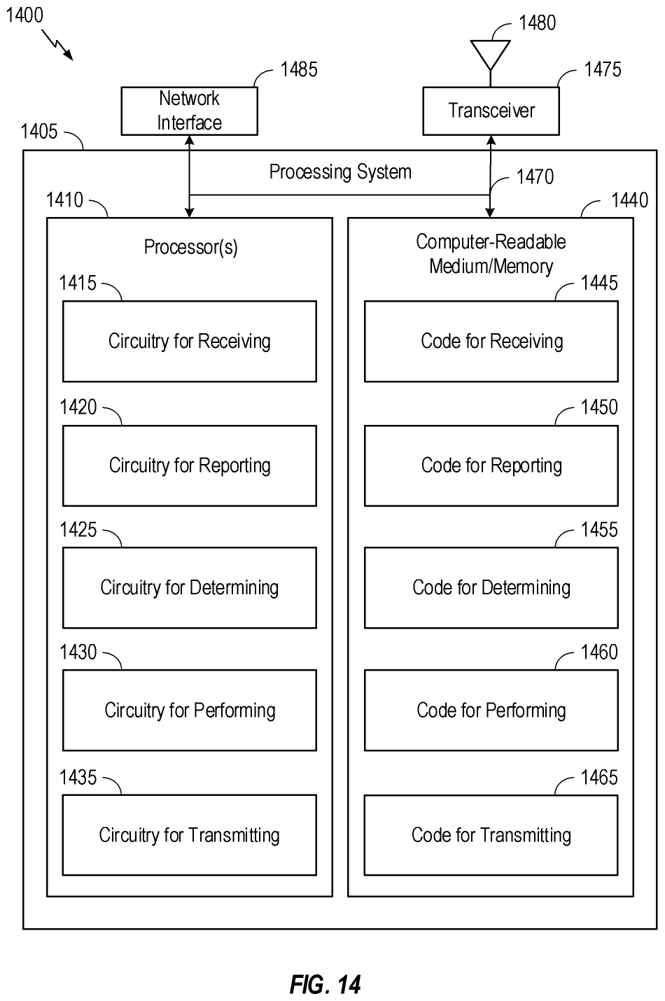

Method 1200 begins at step 1205 with receiving signaling configuring the UE to report time correlation for multiple lags of RS, wherein each lag represents a separation in time between reference signals measured for time correlation. In some cases, the operations of this step refer to, or may be performed by, circuitry for receiving and/or code for receiving as described with reference to FIG. 14.

Method 1200 then proceeds to step 1210 with reporting time correlation for a subset of the multiple configured lags. In some cases, the operations of this step refer to, or may be performed by, circuitry for reporting and/or code for reporting as described with reference to FIG. 14.

In some aspects, the method 1200 further includes determining the subset based on measurement availability of the reference signals. In some cases, the operations of this step refer to, or may be performed by, circuitry for determining and/or code for determining as described with reference to FIG. 14.

In some aspects, the method 1200 further includes reporting a codepoint representing in invalid time correlation value for one or more of the configured lags that are not in the subset. In some cases, the operations of this step refer to, or may be performed by, circuitry for reporting and/or code for reporting as described with reference to FIG. 14.

In some aspects, reporting time correlation for the subset of the multiple configured lags comprises: indicating, in a first reporting field, which lags are in the subset; and indicating, in a second reporting field, time correlation values for the lags indicated in the first reporting stage.

In some aspects, the signaling configuring the UE to report time correlation for multiple lags of RS indicates at least one of: a maximum lag for time correlation reporting, a maximum number of lags configured for time correlation reporting, or a maximum number of lags with time correlation values reported in a single report.

In some aspects, the method 1200 further includes performing normalization on reported time correlation values, wherein for time-correlation with a single sample, the normalization is determined by a product of a sum of a square of received signal amplitude at each RE of two reference signals separated by a lag. In some cases, the operations of this step refer to, or may be performed by, circuitry for performing and/or code for performing as described with reference to FIG. 14.

In some aspects, time correlation values for different lags are reported with different quantization intervals.

In some aspects, time correlation values are reported in a range from zero to one; a first lag has more quantization intervals near one than near zero; and a second lag, larger than the first lag, has more quantization intervals near zero than near one.

In some aspects, the signaling configures the UE to report time correlation for multiple bursts of aperiodic TRS.

In some aspects, the signaling configures the UE to report time correlation for multiple bursts of single-port CSI-RS with different time spacings than configured for TRS.

In some aspects, the signaling configures the UE to report time correlation for multiple bursts of single-port CSI-RS and one or more bursts of TRS.

In some aspects, the UE is configured to report time correlation value for a lag based on a pair of most recent bursts of TRS; bursts of the pair are separated by the lag; and the pair of most recent bursts is no later than a timeline anchor slot.

In some aspects, the UE is configured to report most recent time correlation values of one or more lags based on: TRS received within an DRX active time; or TRS received within a DRX on duration outside of the DRX active time, if the UE is configured with a WUS.

In some aspects, the UE reports time correlation for only the subset of the multiple configured lags, regardless of whether TRS is received within a DRX active time or outside the DRX active time.

In one aspect, method 1200, or any aspect related to it, may be performed by an apparatus, such as communications device 1400 of FIG. 14, which includes various components operable, configured, or adapted to perform the method 1200. Communications device 1400 is described below in further detail.

Note that FIG. 12 is just one example of a method, and other methods including fewer, additional, or alternative steps are possible consistent with this disclosure.

### Example Operations of a Network Entity

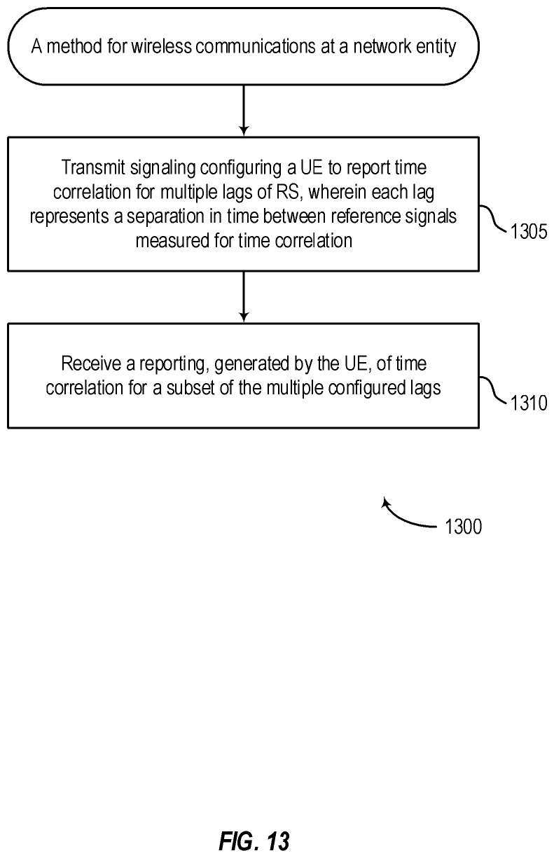

FIG. 13 shows an example of a method 1300 for wireless communications at a network entity, such as a BS 102 of FIGS. 1 and 3, or a disaggregated base station as discussed with respect to FIG. 2.

Method 1300 begins at step 1305 with transmitting signaling configuring a UE to report time correlation for multiple lags of RS, wherein each lag represents a separation in time between reference signals measured for time correlation. In some cases, the operations of this step refer to, or may be performed by, circuitry for transmitting and/or code for transmitting as described with reference to FIG. 14.

Method 1300 then proceeds to step 1310 with receiving a reporting, generated by the UE, of time correlation for a subset of the multiple configured lags. In some cases, the operations of this step refer to, or may be performed by, circuitry for receiving and/or code for receiving as described with reference to FIG. 14.

In some aspects, the method 1300 further includes determining the subset based on measurement availability of the reference signals. In some cases, the operations of this step refer to, or may be performed by, circuitry for determining and/or code for determining as described with reference to FIG. 14.

In some aspects, the reporting includes a codepoint representing in invalid time correlation value for one or more of the configured lags that are not in the subset.

In some aspects, the reporting time comprises: a first reporting field that indicates which lags are in the subset; and a second reporting field that indicates time correlation values for the lags indicated in the first reporting stage.

In some aspects, the signaling configuring the UE to report time correlation for multiple lags of RS indicates at least one of: a maximum lag for time correlation reporting, a maximum number of lags configured for time correlation reporting, or a maximum number of lags with time correlation values reported in a single report.

In some aspects, time correlation values for different lags are reported with different quantization intervals.

In some aspects, time correlation values are reported in a range from zero to one; a first lag has more quantization intervals near one than near zero; and a second lag, larger than the first lag, has more quantization intervals near zero than near one.

In some aspects, the signaling configures the UE to report time correlation for multiple bursts of aperiodic TRS.

In some aspects, the signaling configures the UE to report time correlation for multiple bursts of single-port CSI-RS with different time spacings than configured for TRS.

In some aspects, the signaling configures the UE to report time correlation for multiple bursts of single-port CSI-RS and one or more bursts of TRS.

In some aspects, the UE is configured to report time correlation value for a lag based on a pair of most recent bursts of TRS; bursts of the pair are separated by the lag; and the pair of most recent bursts is no later than a timeline anchor slot.

In some aspects, the UE is configured to report most recent time correlation values of one or more lags based on: TRS received within an DRX active time; or TRS received within a DRX on duration outside of the DRX active time, if the UE is configured with a WUS.

In one aspect, method 1300, or any aspect related to it, may be performed by an apparatus, such as communications device 1400 of FIG. 14, which includes various components operable, configured, or adapted to perform the method 1300. Communications device 1400 is described below in further detail.

Note that FIG. 13 is just one example of a method, and other methods including fewer, additional, or alternative steps are possible consistent with this disclosure.

### Example Communications Device

FIG. 14 depicts aspects of an example communications device 1400. In some aspects, communications device 1400 is a user equipment, such as UE 104 described above with respect to FIGS. 1 and 3. In some aspects, communications device 1400 is a network entity, such as BS 102 of FIGS. 1 and 3, or a disaggregated base station as discussed with respect to FIG. 2.

The communications device 1400 includes a processing system 1405 coupled to the transceiver 1475 (e.g., a transmitter and/or a receiver). In some aspects (e.g., when communications device 1400 is a network entity), processing system 1405 may be coupled to a network interface 1485 that is configured to obtain and send signals for the communications device 1400 via communication link(s), such as a backhaul link, midhaul link, and/or fronthaul link as described herein, such as with respect to FIG. 2. The transceiver 1475 is configured to transmit and receive signals for the communications device 1400 via the antenna 1480, such as the various signals as described herein. The processing system 1405 may be configured to perform processing functions for the communications device 1400, including processing signals received and/or to be transmitted by the communications device 1400.

The processing system 1405 includes one or more processors 1410. In various aspects, the one or more processors 1410 may be representative of one or more of receive processor 358, transmit processor 364, TX MIMO processor 366, and/or controller/processor 380, as described with respect to FIG. 3. In various aspects, one or more processors 1410 may be representative of one or more of receive processor 338, transmit processor 320, TX MIMO processor 330, and/or controller/processor 340, as described with respect to FIG. 3. The one or more processors 1410 are coupled to a computer-readable medium/memory 1440 via a bus 1470. In certain aspects, the computer-readable medium/memory 1440 is configured to store instructions (e.g., computer-executable code) that when executed by the one or more processors 1410, cause the one or more processors 1410 to perform: the method 1200 described with respect to FIG. 12, or any aspect related to it; and/or the method 1300 described with respect to FIG. 13, or any aspect related to it. Note that reference to a processor performing a function of communications device 1400 may include one or more processors 1410 performing that function of communications device 1400.

In the depicted example, computer-readable medium/memory 1440 stores code (e.g., executable instructions), such as code for receiving 1445, code for reporting 1450, code for determining 1455, code for performing 1460, and code for transmitting 1465. Processing of the code for receiving 1445, code for reporting 1450, code for determining 1455, code for performing 1460, and code for transmitting 1465 may cause the communications device 1400 to perform: the method 1200 described with respect to FIG. 12, or any aspect related to it; and/or the method 1300 described with respect to FIG. 13, or any aspect related to it.

The one or more processors 1410 include circuitry configured to implement (e.g., execute) the code stored in the computer-readable medium/memory 1440, including circuitry such as circuitry for receiving 1415, circuitry for reporting 1420, circuitry for determining 1425, circuitry for performing 1430, and circuitry for transmitting 1435. Processing with circuitry for receiving 1415, circuitry for reporting 1420, circuitry for determining 1425, circuitry for performing 1430, and circuitry for transmitting 1435 may cause the communications device 1400 to perform: the method 1200 described with respect to FIG. 12, or any aspect related to it; and/or the method 1300 described with respect to FIG. 13, or any aspect related to it.

Various components of the communications device 1400 may provide means for performing: the method 1200 described with respect to FIG. 12, or any aspect related to it; and/or the method 1300 described with respect to FIG. 13, or any aspect related to it. For example, means for transmitting, sending or outputting for transmission may include transceivers 354 and/or antenna(s) 352 of the UE 104 illustrated in FIG. 3, transceivers 332 and/or antenna(s) 334 of the BS 102 illustrated in FIG. 3, and/or the transceiver 1475 and the antenna 1480 of the communications device 1400 in FIG. 14. Means for receiving or obtaining may include transceivers 354 and/or antenna(s) 352 of the UE 104 illustrated in FIG. 3, transceivers 332 and/or antenna(s) 334 of the BS 102 illustrated in FIG. 3, and/or the transceiver 1475 and the antenna 1480 of the communications device 1400 in FIG. 14.

### EXAMPLE CLAUSES

Implementation examples are described in the following numbered clauses:
Clause 1: A method for wireless communications at a UE, comprising: receiving signaling configuring the UE to report time correlation for multiple lags of RS, wherein each lag represents a separation in time between reference signals measured for time correlation; and reporting time correlation for a subset of the multiple configured lags.
Clause 2: The method of Clause 1, further comprising: determining the subset based on measurement availability of the reference signals.
Clause 3: The method of any one of Clauses 1 and 2, further comprising: reporting a codepoint representing in invalid time correlation value for one or more of the configured lags that are not in the subset.
Clause 4: The method of any one of Clauses 1-3, wherein reporting time correlation for the subset of the multiple configured lags comprises: indicating, in a first reporting field, which lags are in the subset; and indicating, in a second reporting field, time correlation values for the lags indicated in the first reporting stage.
Clause 5: The method of any one of Clauses 1-4, wherein the signaling configuring the UE to report time correlation for multiple lags of RS indicates at least one of: a maximum lag for time correlation reporting, a maximum number of lags configured for time correlation reporting, or a maximum number of lags with time correlation values reported in a single report.
Clause 6: The method of any one of Clauses 1-5, further comprising: performing normalization on reported time correlation values, wherein for time-correlation with a single sample, the normalization is determined by a product of a sum of a square of received signal amplitude at each RE of two reference signals separated by a lag.
Clause 7: The method of any one of Clauses 1-6, wherein: time correlation values for different lags are reported with different quantization intervals.
Clause 8: The method of Clause 7, wherein: time correlation values are reported in a range from zero to one; a first lag has more quantization intervals near one than near zero; and a second lag, larger than the first lag, has more quantization intervals near zero than near one.
Clause 9: The method of any one of Clauses 1-8, wherein: the signaling configures the UE to report time correlation for multiple bursts of aperiodic TRS.
Clause 10: The method of any one of Clauses 1-9, wherein: the signaling configures the UE to report time correlation for multiple bursts of single-port CSI-RS with different time spacings than configured for TRS.
Clause 11: The method of any one of Clauses 1-10, wherein: the signaling configures the UE to report time correlation for multiple bursts of single-port CSI-RS and one or more bursts of TRS.
Clause 12: The method of any one of Clauses 1-11, wherein: the UE is configured to report time correlation value for a lag based on a pair of most recent bursts of TRS; bursts of the pair are separated by the lag; and the pair of most recent bursts is no later than a timeline anchor slot.
Clause 13: The method of any one of Clauses 1-12, wherein the UE is configured to report most recent time correlation values of one or more lags based on: TRS received within an DRX active time; or TRS received within a DRX on duration outside of the DRX active time, if the UE is configured with a WUS.
Clause 14: The method of any one of Clauses 1-13, wherein the UE reports time correlation for only the subset of the multiple configured lags, regardless of whether TRS is received within a DRX active time or outside the DRX active time.
Clause 15: A method for wireless communications at a network entity, comprising: transmitting signaling configuring a UE to report time correlation for multiple lags of RS, wherein each lag represents a separation in time between reference signals measured for time correlation; and receiving a reporting, generated by the UE, of time correlation for a subset of the multiple configured lags.
Clause 16: The method of Clause 15, further comprising: determining the subset based on measurement availability of the reference signals.
Clause 17: The method of any one of Clauses 15 and 16, wherein the reporting includes a codepoint representing in invalid time correlation value for one or more of the configured lags that are not in the subset.
Clause 18: The method of any one of Clauses 15-17, wherein the reporting time comprises: a first reporting field that indicates which lags are in the subset; and a second reporting field that indicates time correlation values for the lags indicated in the first reporting stage.
Clause 19: The method of any one of Clauses 15-18, wherein the signaling configuring the UE to report time correlation for multiple lags of RS indicates at least one of: a maximum lag for time correlation reporting, a maximum number of lags configured for time correlation reporting, or a maximum number of lags with time correlation values reported in a single report.
Clause 20: The method of any one of Clauses 15-19, wherein: time correlation values for different lags are reported with different quantization intervals.
Clause 21: The method of Clause 20, wherein: time correlation values are reported in a range from zero to one; a first lag has more quantization intervals near one than near zero; and a second lag, larger than the first lag, has more quantization intervals near zero than near one.
Clause 22: The method of any one of Clauses 15-21, wherein: the signaling configures the UE to report time correlation for multiple bursts of aperiodic TRS.
Clause 23: The method of any one of Clauses 15-22, wherein: the signaling configures the UE to report time correlation for multiple bursts of single-port CSI-RS with different time spacings than configured for TRS.
Clause 24: The method of any one of Clauses 15-23, wherein: the signaling configures the UE to report time correlation for multiple bursts of single-port CSI-RS and one or more bursts of TRS.
Clause 25: The method of any one of Clauses 15-24, wherein: the UE is configured to report time correlation value for a lag based on a pair of most recent bursts of TRS; bursts of the pair are separated by the lag; and the pair of most recent bursts is no later than a timeline anchor slot.
Clause 26: The method of any one of Clauses 15-25, wherein the UE is configured to report most recent time correlation values of one or more lags based on: TRS received within an DRX active time; or TRS received within a DRX on duration outside of the DRX active time, if the UE is configured with a WUS.
Clause 27: An apparatus, comprising: a memory comprising executable instructions; and a processor configured to execute the executable instructions and cause the apparatus to perform a method in accordance with any one of Clauses 1-26.
Clause 28: An apparatus, comprising means for performing a method in accordance with any one of Clauses 1-26.
Clause 29: A non-transitory computer-readable medium comprising executable instructions that, when executed by a processor of an apparatus, cause the apparatus to perform a method in accordance with any one of Clauses 1-26.
Clause 30: A computer program product embodied on a computer-readable storage medium comprising code for performing a method in accordance with any one of Clauses 1-26.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method for wireless communications at a user equipment (UE), comprising:
receiving signaling configuring the UE to report time correlation for multiple lags of reference signals (RS), wherein each lag represents a separation in time between reference signals measured for time correlation; and
reporting time correlation for a subset of the multiple configured lags.

2. The method of claim 1, further comprising determining the subset based on measurement availability of the reference signals.

3. The method of claim 1, further comprising reporting a codepoint representing in invalid time correlation value for one or more of the configured lags that are not in the subset.

4. The method of claim 1, wherein reporting time correlation for the subset of the multiple configured lags comprises:
indicating, in a first reporting field, which lags are in the subset; and
indicating, in a second reporting field, time correlation values for the lags indicated in the first reporting stage.

5. The method of claim 1, wherein the signaling configuring the UE to report time correlation for multiple lags of RS indicates at least one of:
a maximum lag for time correlation reporting, a maximum number of lags configured for time correlation reporting, or a maximum number of lags with time correlation values reported in a single report.

6. The method of claim 1, further comprising:
performing normalization on reported time correlation values, wherein for time-correlation with a single sample, the normalization is determined by a product of a sum of a square of received signal amplitude at each resource element (RE) of two reference signals separated by a lag.

7. The method of claim 1, wherein:
time correlation values for different lags are reported with different quantization intervals.

8. The method of claim 7, wherein:
time correlation values are reported in a range from zero to one;
a first lag has more quantization intervals near one than near zero; and
a second lag, larger than the first lag, has more quantization intervals near zero than near one.

9. The method of claim 1, wherein:
the signaling configures the UE to report time correlation for multiple bursts of aperiodic tracking reference signals (TRS).

10. The method of claim 1, wherein:
the signaling configures the UE to report time correlation for multiple bursts of single-port channel state information reference signals (CSI-RS) with different time spacings than configured for tracking reference signals (TRS).

11. The method of claim 1, wherein:
the signaling configures the UE to report time correlation for multiple bursts of single-port channel state information reference signals (CSI-RS) and one or more bursts of tracking reference signals (TRS).

12. The method of claim 1, wherein:
the UE is configured to report time correlation value for a lag based on a pair of most recent bursts of tracking reference signals (TRS);
bursts of the pair are separated by the lag; and
the pair of most recent bursts is no later than a timeline anchor slot.

13. The method of claim 1, wherein the UE is configured to report most recent time correlation values of one or more lags based on:
tracking reference signals (TRS) received within an discontinuous reception (DRX) active time; or
TRS received within a DRX on duration outside of the DRX active time, if the UE is configured with a wake-up signal (WUS).

14. The method of claim 1, wherein the UE reports time correlation for only the subset of the multiple configured lags, regardless of whether TRS is received within a DRX active time or outside the DRX active time.

15. A method for wireless communications at a network entity, comprising:
transmitting signaling configuring a user equipment (UE) to report time correlation for multiple lags of reference signals (RS), wherein each lag represents a separation in time between reference signals measured for time correlation; and
receiving a reporting, generated by the UE, of time correlation for a subset of the multiple configured lags.

16. The method of claim 15, further comprising determining the subset based on measurement availability of the reference signals.

17. The method of claim 15, wherein the reporting includes a codepoint representing in invalid time correlation value for one or more of the configured lags that are not in the subset.

18. The method of claim 15, wherein the reporting time comprises:
a first reporting field that indicates which lags are in the subset; and
a second reporting field that indicates time correlation values for the lags indicated in the first reporting stage.

19. The method of claim 15, wherein the signaling configuring the UE to report time correlation for multiple lags of RS indicates at least one of:
a maximum lag for time correlation reporting, a maximum number of lags configured for time correlation reporting, or a maximum number of lags with time correlation values reported in a single report.

20-26. (canceled)

27. An apparatus for wireless communications at a user equipment (UE), comprising:
a processing system that includes one or more processors and memory coupled with the one or more processors, the processing system configured to cause the UE to:
receive signaling configuring the UE to report time correlation for multiple lags of reference signals (RS), wherein each lag represents a separation in time between reference signals measured for time correlation; and
report time correlation for a subset of the multiple configured lags.

28-30. (canceled)
